(19) United States
(12) Patent Application Publication
(10) Pub. No.: US 2016/0160531 A1
(43) Pub. Date: Jun. 9, 2016

(54) ELECTROMECHANICAL LOCK

(71) Applicant: ILOQ OY, Oulu (FI)

(72) Inventors: Mika PIIRAINEN, Oulu (FI); Mika KELLOKOSKI, Haukipudas (FI)

(73) Assignee: iLOQ Oy, Oulu (FI)

(21) Appl. No.: 14/896,829

(22) PCT Filed: Jun. 6, 2014
(86) PCT No.: PCT/FI2014/050460

§ 371 Date: Dec. 8, 2015

(30) Foreign Application Priority Data
Jun. 11, 2013 (EP) 13171414.9

(51) Int. Cl. E05B 47/00

(52) U.S. Cl. CPC E05B 47/0012

(57) ABSTRACT

An electromechanical lock includes an electronic circuit configured to read data from external source and match data against predetermined criterion. An access control mechanism includes a drive gear rotatable by electric power and a driven gear meshable with drive gear. Provided that data matches the predetermined criterion, the drive gear meshes with the driven gear and rotates the driven gear such that the access control mechanism is set to an open state. Provided that an external mechanical break-in force is applied to the access control mechanism, the drive gear remains stationary and the driven gear jams in the drive gear such that the access control mechanism remains in a locked state.

### FIELD

The invention relates to an electromechanical lock.

### BACKGROUND

Electromechanical locks are replacing the traditional mechanical locks. Further refinement is needed for making the electromechanical lock to consume as little electric power as possible and also improving the break-in security of the electromechanical lock.

### BRIEF DESCRIPTION

The present invention seeks to provide an improved electromechanical lock.

According to an aspect of the present invention, there is provided an electromechanical lock as specified in claim 1.

### LIST OF DRAWINGS

Example embodiments of the present invention are described below, by way of example only, with reference to the accompanying drawings, in which

FIGS. 1, 2, 3 and 4 illustrate example embodiments of an electromechanical lock;

FIGS. 5, 6 and 7 illustrate example embodiments of an access control mechanism;

FIGS. 8A, 8B, 8C, 8D, 8E and 8F illustrate an example embodiment of a sequence, wherein an access control mechanism is set to an open state; and

FIGS. 9A, 9B and 9C illustrate an example embodiment of a sequence, wherein an access control mechanism remains in a locked state.

### DESCRIPTION OF EMBODIMENTS

The following embodiments are only examples. Although the specification may refer to “an” embodiment in several locations, this does not necessarily mean that each such reference is to the same embodiment(s), or that the feature only applies to a single embodiment. Single features of different embodiments may also be combined to provide other embodiments. Furthermore, words “comprising” and “including” should be understood as not limiting the described embodiments to consist of only those features that have been mentioned and such embodiments may contain also features/structures that have not been specifically mentioned.

The Applicant has invented many improvements for the electromechanical locks, such as those disclosed in EP applications 05112272.9, 07112677.5, 07112676.7, 07112673.4, 09180117.5, and 12171614.6, for example. A complete discussion of all those details is not repeated here, but the reader is advised to consult those applications.

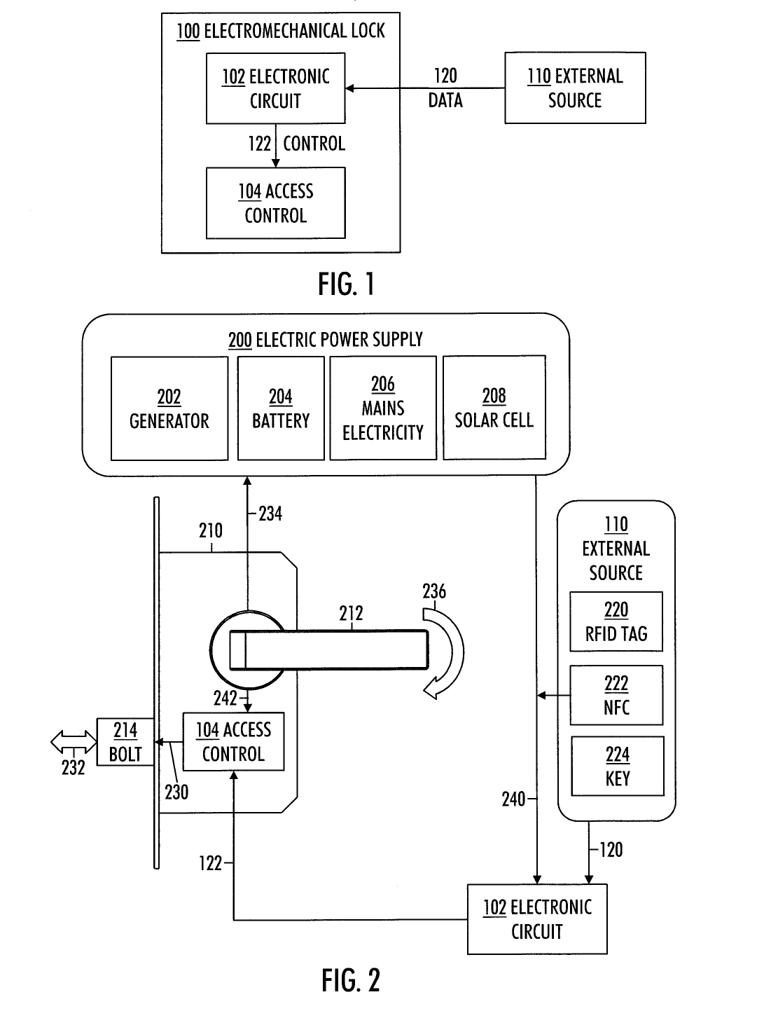

Let us now turn to FIG. 1, which illustrates an example embodiment of an electromechanical lock 100, but with only such parts shown that are relevant to the present example embodiments.

The electromechanical lock 100 comprises an electronic circuit 102 configured to read data 120 from an external source 110 and match the data 120 against a predetermined criterion. In an example embodiment, besides reading, the electronic circuit 102 may also write data 120 to the external source 110.

The electromechanical lock 100 also comprises an access control mechanism 104.

As shown in FIG. 1, the electronic circuit 102 electrically controls 122 the access control mechanism 104.

FIG. 2 illustrates further example embodiments of the electromechanical lock 100.

An electric power supply 200 powers 240 both the electronic circuit 102 and the access control mechanism 104.

In an example embodiment, electric energy required by the access control mechanism 104 is generated in a self-powered fashion within the electromechanical lock 100.

In an example embodiment, the electric power supply 200 comprises a generator 202.

In an example embodiment, pushing down 236 a door handle 212 may operate 234 the generator 202.

In an example embodiment, pushing down 236 the door handle 212 may also mechanically affect 242 the access control mechanism 104.

In an example embodiment, the electric power supply 200 comprises a battery 204. The battery 204 may be a single use or rechargeable accumulator, possibly based on at least one electrochemical cell.

In an example embodiment, the electric power supply 200 comprises mains electricity 206, i.e., the electromechanical lock 100 may be coupled to the general-purpose alternating-current electric power supply.

In an example embodiment, electric energy required by the access control mechanism 104 is sporadically imported from some external source.

In an example embodiment, the electric power supply 200 comprises a solar cell 208 that converts the energy of light directly into electricity by the photovoltaic effect.

In an example embodiment, the electric energy may be obtained from a radio frequency field utilized in radio-frequency identification (RFID) technology.

In an example embodiment, the external source 110 comprises a RFID tag 220 containing the data 120.

In an example embodiment, the external source 110 comprises NFC (Near Field Communication) technology 222 containing the data 120, i.e., a smartphone or some other user terminal holds the data 120. NFC is a set of standards for smartphones and similar devices to establish radio communication with each other by touching them together or bringing them into close proximity. In an example embodiment, NFC technology 222 may be utilized to obtain 240 the electric energy for the electronic circuit 102 and possibly also for the access control mechanism 104.

In an example embodiment, the external source 110 comprises a key 224 containing the data 120.

In an example embodiment, the key 224 comprises the RFID tag 220 containing the data 120.

As is shown in FIG. 2, in an example embodiment, the electromechanical lock 100 may be placed in a lock body 210, and the access control mechanism 104 may control 230 a lock bolt 214 moving 232 in and out of the lock body 210.

FIGS. 3 and 4 show a further example embodiment of the electromechanical lock 100: the electronic circuit 102 and the access control mechanism 104 may be placed inside a lock cylinder 300. The lock cylinder 300 may be placed into the lock body 210 and the lock cylinder 300 may interact 230 with the lock bolt 214.

Furthermore, the electric power supply 200 comprises the generator 202 and the external source 110 comprises the key 224. As the key 224 is inserted 402 into a keyway 400 of the lock cylinder 300, the generator 202 is mechanically rotated 404, and, furthermore, as the key 224 is inserted in the keyway 400, the access control mechanism 104 is electronically controlled and mechanically manipulated 406.

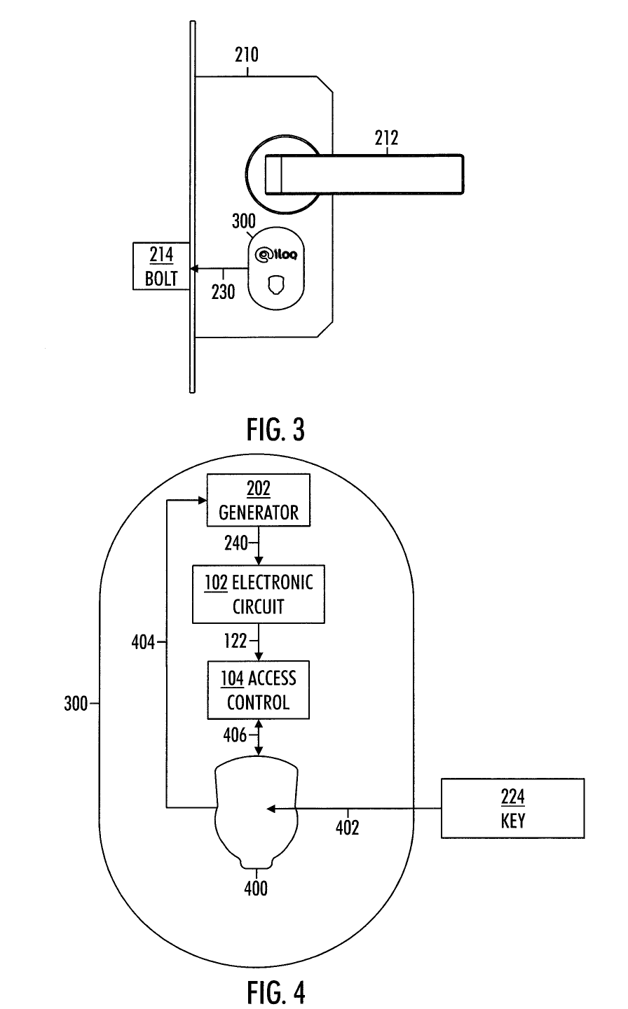

Let us next study the access control mechanism 104 in more detail with reference to FIGS. 5, 6 and 7. FIG. 5 is a general illustration. FIG. 6 shows the rotation directions 602, 604. FIG. 7 illustrates detail 600 of FIG. 6.

The access control mechanism 104 comprises a drive gear 502, 504 rotatable by electric power and a driven gear 506, 508. The driven gear 502, 504 is meshable with the drive gear 506, 508.

In an example embodiment, a cog wheel of the drive gear 502, 504 is coupled with a cog wheel of the driven gear 506, 508 in order to achieve the gear meshing.

In an example embodiment, the drive gear rotates 502, 504 clockwise 602, causing the driven gear 506, 508 to rotate anticlockwise 604. Naturally, the rotation directions may also be the other way round.

In an example embodiment an electric motor 500 rotates the drive gear 502, 504 with the electric power. In an example embodiment, the cog wheel(s) of the drive gear 502, 504 are coupled to a drive shaft 510 of the electric motor 500.

In an example embodiment, the electric motor 500 also acts as the generator 202.

In an example embodiment, the cog wheel(s) of the driven gear 506, 508 are coupled to the same pin 512 coupled with the electromechanical lock 100.

In an example embodiment, the drive gear 502, 504 further comprises a pre-drive gear and the driven gear 506, 508 further comprises a pre-driven gear.

For the sake of clarity, for the embodiments with the pre-drive gear 502 and the pre-driven gear 508, let us call the reference numeral 502 as the drive gear, the reference numeral 504 as the pre-drive gear, the reference numeral 506 as the driven gear, and the reference numeral 508 as the pre-driven gear.

In an example embodiment, the pre-drive gear 504 is co-axial to the drive gear 502.

In an example embodiment, the pre-driven gear 508 is co-axial to the driven gear 506.

In an example embodiment, the pre-drive gear 504 and the drive gear 502 are side-by-side in an axial direction: side-by-side in the drive shaft 510, for example.

In an example embodiment, the pre-driven gear 508 and the driven gear 508 are side-by-side in an axial direction: side-by-side in the pin 512, for example.

In an example embodiment, the pre-drive gear 504 and the drive gear 502 are positioned and formed such that the drive gear 502 is missing teeth on that sector that is operated by the pre-drive gear 504.

In an example embodiment, the pre-driven gear 508 and the driven gear 506 are positioned and formed such that the driven gear 506 is missing teeth on that sector that is operated by the pre-driven gear 508.

Now that the general structure of the access control mechanism 104 has been described, let us study the dynamic behavior of it.

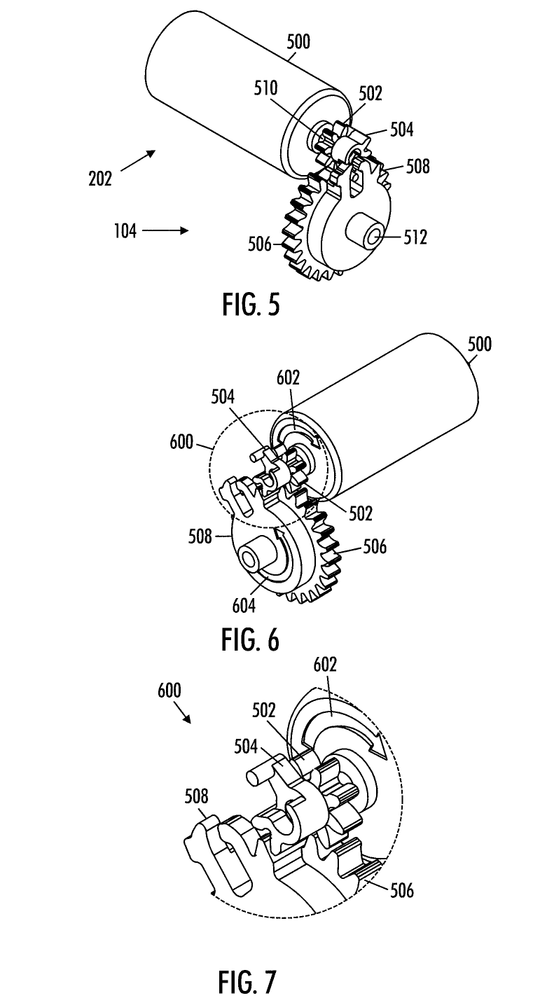

First, FIGS. 8A, 8B, 8C, 8D, 8E and 8F illustrate an example embodiment of a sequence, wherein the access control mechanism 104 is set to an open state.

Provided that the data 120 matches the predetermined criterion, the drive gear 502, 504 meshes with the driven gear 506, 508 and rotates the driven gear 506, 508 such that the access control mechanism 104 is set to an open state. As the core of the present embodiments is not the whole access control mechanism 104, all details of it are not described. It suffices to say that the open state is realized by a predetermined amount of rotation of the driven gear 506, 508; naturally, other mechanical structures may be coupled with the pin 512, i.e., as the driven gear 506, 508 is allowed to rotate, the other mechanical structures may thereby also be set to an open state. Furthermore, additional mechanical energy may also be required to set the other mechanical structures to the open state: through rotation of the key 224, for example.

In an example embodiment, illustrated in FIGS. 8A to 8F, provided that the data 120 matches the predetermined criterion, the pre-drive gear 504 first meshes with the pre-driven gear 508, whereupon the drive gear 502 meshes with the driven gear 506 and rotates the driven gear 506 such that the access control mechanism 104 is set to the open state.

FIG. 8A shows the starting position: all the gears 502, 504, 506, 508 remain stationary.

In FIG. 8B, the motor 500 starts to rotate 602 both the drive gear 502 and the pre-drive gear 504, whereupon the pre-driven gear 508 meshes with the pre-drive gear 504 and both the pre-driven gear 508 and the driven gear 506 start to rotate 604 as well.

In FIGS. 8C and 8D, the pre-drive gear 504 continues to rotate 602, causing the further rotation 604 of the pre-driven gear 508 and the driven gear 506.

In FIG. 8E, the pre-drive gear 504 ceases to mesh with the pre-driven gear 508. But, now that the drive gear 502 starts to mesh with the driven gear 506, the rotation 602 of the drive gear 502 continues to rotate 604 the driven gear 506 as well.

FIG. 8F shows the progression of the rotation 602, 604. Depending on the design parameters, the rotation 602, 604 may be continued until a predetermined open position for the access control mechanism 104 is reached.

In an example embodiment, provided that the data 120 matches the predetermined criterion, the pre-drive gear 504 first meshes with the pre-driven gear 508 and rotates 602, 604 the drive gear 502 and the driven gear 506 such that the drive gear 502 meshes with the driven gear 506 and rotates the driven gear 506 such that the access control mechanism 104 is set to the open state.

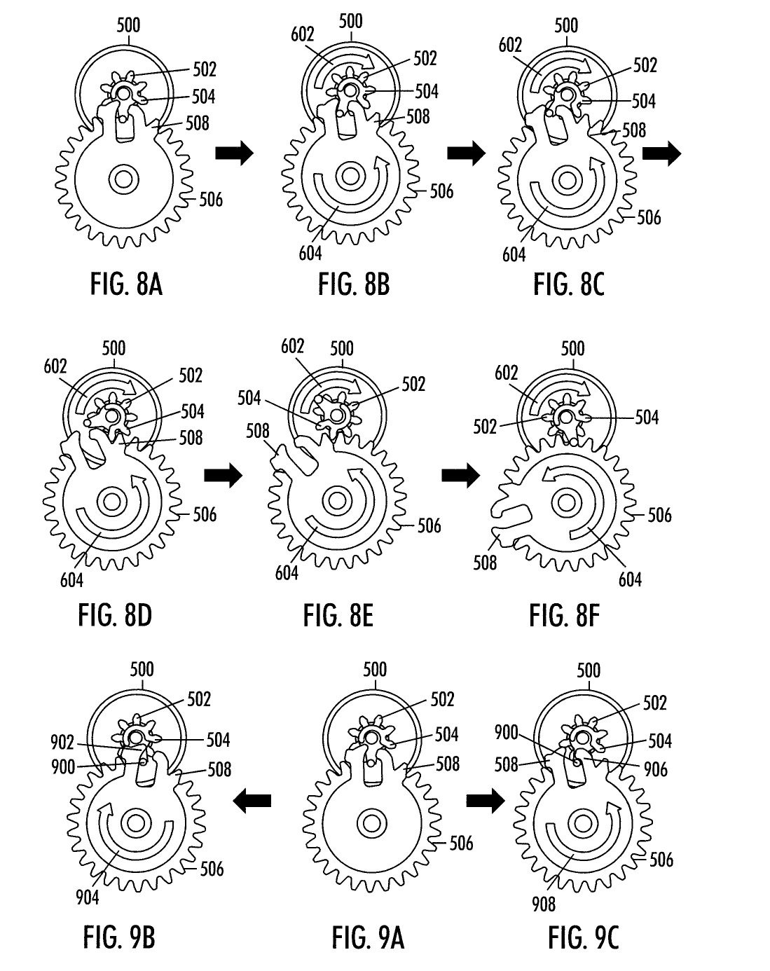

FIGS. 9A, 9B and 9C illustrate an example embodiment of a sequence, wherein the access control mechanism 104 remains in a locked state, despite the fact that the electromechanical lock 100 is subjected to an unauthorized entry attempt. An external mechanical break-in force may be applied to the electromechanical lock 100: by subjecting the electromechanical lock 100 to hammer blows or vibration caused by a suitable tool, for example.

In an example embodiment, provided that an external mechanical break-in force is applied to the access control mechanism 104, the drive gear remains 502, 504 stationary and the driven gear 506, 508 jams in the drive gear 502, 504 such that the access control mechanism 104 remains in a locked state.

In an example embodiment, provided that the external mechanical break-in force is applied to the access control mechanism 104, the pre-drive gear 504 remains stationary, and the pre-driven gear 508 jams in the pre-drive gear 504, whereby the drive gear 502 remains stationary such that the access control mechanism 104 remains in the locked state.

In an example embodiment, as the drive gear 502 and the pre-drive gear 504 are both coupled with the motor 500, the internal inertia (caused by brushes of the motor, for example) sufficiently prevents the rotation.

In an example embodiment, provided that the external mechanical break-in force is applied to the access control mechanism 104, the pre-drive gear 504 remains stationary and the pre-driven gear 508 jams in the pre-drive gear 504 such that the drive gear 502 and the driven gear 506 are obstructed from further rotating to mesh with each other and the access control mechanism 104 remains in the locked state.

FIG. 9A shows the starting position: all the gears 502, 504, 506, 508 remain stationary.

In FIG. 9B, the external break-in force causes the driven gear 506 and the pre-driven gear 508 to rotate 904 clockwise.

In FIG. 9C, the external break-in force causes the driven gear 506 and the pre-driven gear 508 to rotate 908 anticlockwise.

In an example embodiment, the pre-drive gear 504 and the pre-driven gear 508 are formed such that the pre-driven gear 508 jams in the pre-drive gear 504 with both clockwise 904 and anticlockwise 908 rotation such that the drive gear 502 and the driven gear 506 are obstructed from further rotating to mesh with each other and the access control mechanism 104 remains in the locked state.

In an example embodiment, the pre-drive gear 504 comprises a pin 900 in one tooth, and the pre-driven gear 508 comprises a hook 906 in one tooth, wherein, provided that the data 120 matches the predetermined criterion, the pre-drive gear 504 meshes with the pre-driven gear 508 such that the tooth with the pin 900 rotates the pre-driven gear 508 without jamming with the hook 906, as shown in the sequence of FIGS. 8B, 8C and 8D, or, provided that the external mechanical break-in force is applied to the access control mechanism 104, the pre-drive gear 504 remains stationary and the pre-driven gear 508 jams in the pre-drive gear 504 such that the hook 906, 902 jams with the pin 900, as shown in either FIG. 9B or 9C. In a further example embodiment, the pre-driven gear comprises two hooks 902, 906 each in its own tooth positioned such that the pin 900 is between the two hooks 902, 906 in the locked position, as shown in FIG. 9A.

It will be obvious to a person skilled in the art that, as technology advances, the inventive concept can be implemented in various ways. The invention and its embodiments are not limited to the example embodiments described above but may vary within the scope of the claims.

1. An electromechanical lock, comprising an electronic circuit configured to read data from an external source and match the data against a predetermined criterion, and an access control mechanism comprising a drive gear rotatable by electric power and a driven gear meshable with the drive gear,
wherein, provided that the data matches the predetermined criterion, the drive gear meshes with the driven gear and rotates the driven gear such that the access control mechanism is set to an open state,
or, provided that an external mechanical break-in force is applied to the access control mechanism, the drive gear remains stationary and the driven gear jams in the drive gear such that the access control mechanism remains in a locked state.

2. The apparatus of claim 1, wherein the drive gear further comprises a pre-drive gear and the driven gear further comprises a pre-driven gear.

3. The apparatus of claim 2, wherein the pre-drive gear is co-axial to the drive gear.

4. The apparatus of claim 2, wherein the pre-driven gear is co-axial to the driven gear.

5. The apparatus of claim 2, wherein the pre-drive gear and the drive gear are side-by-side in an axial direction.

6. The apparatus of claim 2, wherein the pre-driven gear and the driven gear are side-by-side in an axial direction.

7. The apparatus of claim 2, wherein the pre-drive gear and the drive gear are positioned and formed such that the drive gear is missing teeth on that sector that is operated by the pre-drive gear.

8. The apparatus of claim 2, wherein the pre-driven gear and the driven gear are positioned and formed such that the driven gear is missing teeth on that sector that is operated by the pre-driven gear.

9. The apparatus of claim 2, wherein,
provided that the data matches the predetermined criterion, the pre-drive gear first meshes with the pre-driven gear, whereupon the drive gear meshes with the driven gear and rotates the driven gear such that the access control mechanism is set to the open state.

10. The apparatus of claim 2, wherein,
provided that the external mechanical break-in force is applied to the access control mechanism, the pre-drive gear remains stationary, and the pre-driven gear jams in the pre-drive gear, whereby the drive gear remains stationary such that the access control mechanism remains in the locked state.

11. The apparatus of claim 2, wherein the pre-drive gear and the pre-driven gear are formed such that the pre-driven gear jams in the pre-drive gear with both clockwise and anticlockwise rotation such that the drive gear and the driven gear are obstructed from further rotating to mesh with each other and the access control mechanism remains in the locked state.

12. The apparatus of claim 2, wherein, provided that the data matches the predetermined criterion, the pre-drive gear first meshes with the pre-driven gear and rotates the drive gear and the driven gear such that the drive gear meshes with the driven gear and rotates the driven gear such that the access control mechanism is set to the open state.

13. The apparatus of claim 2, wherein, provided that the external mechanical break-in force is applied to the access control mechanism, the pre-drive gear remains stationary and the pre-driven gear jams in the pre-drive gear such that the drive gear and the driven gear are obstructed from further rotating to mesh with each other and the access control mechanism remains in the locked state.

14. The apparatus of claim 2, wherein the pre-drive gear comprises a pin in one tooth, and the pre-driven gear comprises a hook in one tooth, wherein, provided that the data matches the predetermined criterion, the pre-drive gear meshes with the pre-driven gear such that the tooth with the pin rotates the pre-driven gear without jamming with the hook, or, provided that the external mechanical break-in force is applied to the access control mechanism, the pre-drive gear remains stationary and the pre-driven gear jams in the pre-drive gear such that the hook jams with the pin.

15. The apparatus of claim 14, wherein the pre-driven gear comprises two hooks each in its own tooth positioned such that the pin is between the two hooks in the locked position.
